(19) United States
(12) Patent Application Publication
(10) Pub. No.: US 2024/0263324 A1
(43) Pub. Date: Aug. 8, 2024

(54) IRIDIUM/RUTHENIUM-BASED ANODE CATALYST FOR WATER ELECTROLYSIS, METHOD FOR PREPARING SAME, AND WATER ELECTROLYSIS DEVICE USING SAME

(71) Applicant: Korea University Research and Business Foundation, Seoul (KR)

(72) Inventors: Kwang-Yeol LEE, Seoul (KR); Jin-Whan JOO, Seoul (KR); Ye-ji PARK, Uijeongbu-si (KR)

(73) Assignee: Korea University Research and Business Foundation, Seoul (KR)

(21) Appl. No.: 18/565,723

(22) PCT Filed: May 24, 2022
(86) PCT No.: PCT/KR2022/007326

§ 371 Date: Mar. 25, 2024

(30) Foreign Application Priority Data
May 31, 2021 (KR) 10-2021-0070072
May 9, 2022 (KR) 10-2022-0056360

(51) Int. Cl. C25B 11/037; C25B 1/04; C25B 11/042

(52) U.S. Cl. CPC C25B 11/037; C25B 1/04; C25B 11/042

(57) ABSTRACT

An iridium-ruthenium-based oxide anode catalyst for water electrolysis includes a heterostructure within the particles, different phases within the particles being adjacent to each other, and the different phases within the particles consist of iridium and ruthenium, the catalyst is synthesized using metal sulfides (MxS) as precursors, and the catalyst is characterized by the introduction of transition metal elements as dopants.

### CROSS-REFERENCE TO RELATED APPLICATIONS

This application claims priority to and the benefit of Korean Patent Application No. 10-2021-0070072 filed in the Korean Intellectual Property Office on May 31, 2021 and Korean Patent Application No. 10-2022-0056360 filed in the Korean Intellectual Property Office on May 9, 2022, the entire contents of which are incorporated herein by reference.

### TECHNICAL FIELD

This invention relates to an iridium-ruthenium based oxygen-evolving anode catalyst for water electrolysis, its method of preparation, and the water electrolysis device using it.

This invention pertains to an iridium-ruthenium based oxygen-evolving anode catalyst for water electrolysis, its method of preparation, and the water electrolysis device utilizing it. More specifically, it involves introducing a dopant to alter the compositional distribution within the catalyst, thereby enabling the formation of a heterostructure.”

Additionally, this invention relates to an iridium-ruthenium based oxygen-evolving anode catalyst for water electrolysis, designed for high activity and stability in the Oxygen Evolution Reaction (OER), its method of preparation, and the water electrolysis device utilizing it.”

### BACKGROUND

With the global increase in energy demand, the issue of climate change due to the use of fossil fuels is becoming more serious. As a solution to this climate change problem, renewable energy sources such as solar power, wind power, and geothermal energy are receiving increased attention. However, the electricity generated from renewable energy sources is intermittent, necessitating storage in the form of fuel

Furthermore, hydrogen is considered the most promising fuel candidate in this regard. When used as a fuel, hydrogen does not produce pollutants, and extensive research has been conducted to the point where hydrogen vehicles are being commercialized. On the other hand, water electrolysis, the ultimate direction for hydrogen production, faces significant challenges in demonstration and commercialization. Particularly, the Oxygen Evolution Reaction (OER) is known to involve the movement of many electrons and is characterized by a slow reaction rate.

Therefore, to maximize the performance of water electrolysis devices, the development of high-performance and high-durability Oxygen Evolution Reaction (OER) catalysts is essential. Meanwhile, regarding such catalysts for the anode in water electrolysis devices and their manufacturing methods, one can refer to existing prior art documents such as Korean Registered Patents No. 10-1742530 and No. 10-1807287.

### SUMMARY OF THE INVENTION

This invention has been conceived in consideration of and to resolve the problems mentioned in the conventional techniques. The purpose of this invention is to provide an iridium-ruthenium based anode catalyst for water electrolysis that demonstrates excellent catalytic activity and stability while reducing the loading amount of precious metals, especially iridium and ruthenium, along with its method of preparation and the water electrolysis device using it. This invention aims to offer an iridium-ruthenium based anode catalyst for water electrolysis and its preparation method, as well as a water electrolysis device that employs a small amount of dopant to alter the composition distribution of iridium and ruthenium within the catalyst, thereby realizing a heterostructure with a co-doped protruding structure.

The invention facilitates the Oxygen Evolution Reaction (OER) at water electrolysis electrodes through nano-scaled iridium-ruthenium hetero co-doped protruding structure nanoparticles, whose composition is adjusted by the dopant.

Additionally, this invention provides an iridium-ruthenium based anode catalyst for water electrolysis, its preparation method, and a water electrolysis device that ensures high electrocatalytic efficiency and stability for the Oxygen Evolution Reaction (OER) in acidic environments.

Furthermore, the purpose of this invention is to provide an iridium-ruthenium based anode catalyst for water electrolysis that can be easily mass-produced through a solvothermal reaction using a solution containing metal precursors, along with its method of preparation and the water electrolysis device utilizing it.

The invention according to the present invention for achieving the above-mentioned purpose is an iridium-ruthenium-based anode catalyst for water electrolysis, which has a heterostructure where different phases within the particle are adjacent to each other, wherein the different phases within the particle are iridium and ruthenium, synthesized using metal sulfide (MxS) as a precursor, and characterized by the introduction of a transition metal element as a dopant. Herein, the iridium-ruthenium-based anode catalyst may have a configuration with nanoparticles in the shape of nano-cacti. Furthermore, the method for producing an iridium-ruthenium-based anode catalyst for water electrolysis according to the present invention for achieving the above-mentioned purpose is characterized by producing a heterostructure with adjacent different phases within the particle by introducing a transition metal element as a dopant and controlling the reduction rate of the precursor. Moreover, it is characterized in that the different phases within the particle are iridium and ruthenium. Additionally, the method for producing an iridium-ruthenium-based anode catalyst for water electrolysis according to the present invention for achieving the above-mentioned purpose includes the steps of: (A) providing a precursor for synthesizing nanoparticles having a heterostructure; (B) manufacturing an iridium-ruthenium-based anode catalyst with a heterostructure through synthesis using the precursor and a transition metal element as a dopant. Moreover, the water electrolysis device according to the present invention for achieving the above-mentioned purpose may include an oxygen evolution electrode made with the iridium-ruthenium-based anode catalyst for water electrolysis. In addition, the present invention may include an oxygen evolution electrode made with an anode catalyst manufactured by the method for producing an iridium-ruthenium-based anode catalyst. Furthermore, in the present invention, there exist various embodiments for achieving the objectives for each category, and these various embodiments will be described and explained more specifically below.

### BRIEF DESCRIPTION OF THE DRAWINGS

FIG. 1 is a diagram showing the appearance of copper sulfide nano-hexagonal plates used as precursors for synthesizing iridium-ruthenium hetero-joint structure nanoparticles in an embodiment of the present invention.

FIG. 2 is an exemplary diagram illustrating the crystal structure of the copper sulfide nano-hexagonal plates used in the present invention.

FIG. 3 is a diagram showing X-ray diffraction analysis results for various anode catalysts synthesized in the present invention.

FIG. 4 is a diagram showing transmission electron microscopy (TEM) images of various anode catalysts synthesized in the present invention.

FIG. 5 is a diagram showing high-resolution transmission electron microscopy (HRTEM) images and fast Fourier transform (FFT) patterns for the analysis of the physical properties of the synthesized anode catalyst, where a) is the undoped anode catalyst (RuIr NCT), b) is the manganese-doped anode catalyst (Mn—RuIr NCT), and c) is the anode catalyst with five times the amount of manganese dopant (H—Mn—RuIr NCT).

FIG. 6 is a transmission electron microscopy (TEM) image showing particle formation over reaction time for the undoped anode catalyst in the present invention.

FIG. 7 is a transmission electron microscopy (TEM) image showing particle formation over reaction time for the manganese-doped anode catalyst in the present invention.

FIG. 8 is a diagram showing EXD analysis results over reaction time depending on the presence or absence of manganese dopant in the present invention.

FIG. 9 is a diagram showing X-ray diffraction patterns over reaction time for the undoped anode catalyst in the present invention.

FIG. 10 is a diagram showing X-ray diffraction patterns over reaction time for the manganese-doped anode catalyst in the present invention.

FIG. 11 is a diagram showing the composition distribution of iridium and ruthenium for the undoped anode catalyst and the manganese-doped anode catalyst, where a) is the undoped anode catalyst (RuIr NCT) and b) is the manganese-doped anode catalyst (Mn—RuIr NCT).

FIG. 12 is a diagram showing X-ray photoelectron spectroscopy (XPS) results for ruthenium (Ru) and iridium (Ir) of the undoped anode catalyst (RuIr NCT) before activation, after electrochemical activation, and after chronoamperometric measurement in the present invention.

FIG. 13 is a diagram showing X-ray photoelectron spectroscopy (XPS) results for ruthenium (Ru) and iridium (Ir) of the manganese-doped anode catalyst (Mn—RuIr NCT) before activation, after electrochemical activation, and after chronoamperometric measurement in the present invention.

FIG. 14 is a diagram showing the ratio change of iridium (Ir) and ruthenium (Ru) after electrochemical oxidation of the manganese-doped anode catalyst (Mn—RuIr NCT) in the present invention.

FIG. 15 is a diagram showing characteristic analysis for the undoped anode catalyst and the manganese-doped anode catalyst, where a) shows high-resolution TEM (HRTEM) images and FFT patterns after chronoamperometric measurement for the undoped anode catalyst, b) shows EDX mapping images after chronoamperometric measurement for the undoped anode catalyst, c) shows high-resolution TEM (HRTEM) images and FFT patterns after chronoamperometric measurement for the manganese-doped anode catalyst, d) shows EDX mapping images after chronoamperometric measurement for the manganese-doped anode catalyst, e) shows diagrams indicating the particle thickness for both the undoped and manganese-doped anode catalysts, and f) shows diagrams indicating the elemental ratio of Ru and Ir from EDX analysis.

FIG. 16 is a diagram showing the results measured by inductively coupled plasma mass spectrometry (ICP-MS) for the amount of metal leached during 6 hours of chronoamperometric measurement of the oxygen evolution reaction (OER) in the present invention.

FIG. 17 is a diagram showing X-ray diffraction patterns for the undoped anode catalyst (RuIr NCT) and the manganese-doped anode catalyst (Mn—RuIr NCT) after continuous chronoamperometric measurement at a current density of 10 mA/cm-2 for 6 hours in the present invention.

FIG. 18 is a diagram showing characteristic analysis of the anode catalysts in the present invention, where a) shows the OER polarization curves, b) compares the overpotentials at current densities of 10 and 100 mA/cm-2, c) shows Tafel slopes, d) shows Nyquist plots at an overpotential of 190 mV, and e) shows chronoamperometric curves (chronopotentiometric curve) at a current density of 10 mA/cm-2.

FIG. 19 is a diagram showing the OER polarization curves for the initial state and after the 1000th cycle of the anode catalysts in the present invention.

FIG. 20 is a diagram illustrating a water electrolysis device using the iridium-ruthenium-based anode catalyst according to the present invention, where a) is a schematic diagram of a proton exchange membrane water electrolyzer (PEMWE), b) is the PEMWE cell polarization curves before and after a 10-hour chronoamperometric test at 100 mA/cm-2, c) is a graph comparing the PEMWE cell voltages at current densities of 100 and 1000 mA/cm-2 and showing the mass activity at 1.42V and 1.70V, and d) shows chronoamperometric curves at a current density of 100 mA/cm-2.

### DETAILED DESCRIPTION

Referencing the attached drawings for a detailed explanation of embodiments of the invention, terms used to indicate directions in this description are based on the orientation as shown in the Figs, unless otherwise defined or mentioned. The same reference numerals in different embodiments refer to the same elements. Moreover, the thickness or dimensions of each component shown in the drawings may be exaggerated for clarity of explanation and do not necessarily represent the actual proportions or relationships between components.

The inventors of this invention discovered that transition metal ions tend to have various oxidation states, which can regulate the reduction speed of other metal precursors. The redox reaction between transition metal ions and iridium and ruthenium precursors allows for the control of the composition distribution of iridium and ruthenium within nanoparticles. This control over composition distribution results in outstanding oxygen evolution reaction (OER) performance at oxidative potentials while maintaining stability during continuous oxygen evolution reactions (OER). This finding underscores the importance of adjusting the precursor's reduction rate through the introduction of dopants, enabling the development of highly efficient and stable catalysts for water electrolysis applications.

Thus, this invention relates to a water electrolysis anode catalyst and its manufacturing technology, which enhances the oxygen evolution reaction (OER) at the water electrolysis cathode through nanoparticles of an iridium-ruthenium-based hetero co-dendritic structure whose composition is adjusted at the nanoscale by dopants. Particularly, it proposes a catalyst and its manufacturing technology that exhibit high electrocatalytic efficiency and stability for the oxygen evolution reaction (OER) in acidic environments, as well as the application of this technology in water electrolysis devices.

In this invention, the use of transition metals as dopants allows for the creation of an anode catalyst with high activity and stability, where ruthenium and iridium oxides are adjacent to each other forming a hetero interface. Furthermore, it introduces a manufacturing technology for an iridium-ruthenium (RuIr) oxide anode catalyst in the shape of nano cacti doped with transition metal ions, and its application in water electrolysis devices.

This approach not only optimizes the catalyst's performance in promoting oxygen evolution but also ensures its durability and effectiveness in acidic conditions, opening new pathways for efficient and sustainable water electrolysis technologies.

In this invention, metal sulfides (MxS) are used as precursors to implement a co-dendritic structure through a simple solvothermal reaction. The catalysts produced in this manner demonstrate long-term stability and durability for the oxygen evolution reaction (OER) during water electrolysis, as well as low overpotential and Tafel slope, showcasing their effectiveness as anode catalysts. Furthermore, the construction of proton exchange membrane electrolysis devices using these catalysts shows high activity compared to commercial catalysts, indicating significant industrial applicability for this highly efficient and stable anode catalyst manufacturing method and the water electrolysis devices that utilize it.

The following examples will describe the invention in greater detail. However, these examples are intended to illustrate the invention and should not be construed as limiting the scope of the invention.

The oxide anode catalyst for water electrolysis according to this invention has a heterostructure with different phases adjacent within the particles, where these different phases are iridium and ruthenium. More preferably, metal sulfides (MxS) are used as precursors for synthesis, and transition metal elements are introduced as dopants.

Throughout this invention, metal sulfides (MxS) serve as precursors for manufacturing water electrolysis catalysts that simultaneously possess co-dendritic and protruding structures.

In these metal sulfides, M represents a transition metal cation, and S represents a sulfide anion. The MxS can have shapes such as nano hexagonal plates or octahedra, with crystal structures that are either face-centered cubic (FCC) or hexagonal close-packed (HCP).

The metal sulfides (MxS) can be represented by chemical formulas such as Cu₂S, Cu_{1.94}S, Cu_{1.8}S, Cu_{1.75}S, CoS, Co₉S₈, and Co₃S₄. and at least one or more of these can be used.

Below, the manufacturing method of the iridium-ruthenium-based oxide anode catalyst for water electrolysis according to this invention will be described, along with various characterizations. Additionally, the application of this catalyst in water electrolysis devices will also be discussed. This section aims to detail the steps involved in creating the catalyst, the analytical methods used to evaluate its properties and performance, and how it can be implemented in practical water electrolysis systems for enhanced hydrogen production.

### (1) Manufacture of the Oxide Anode Catalyst

### 1) Synthesis of Metal Sulfides (MxS)

Metal sulfides (MxS) are utilized in the synthesis of iridium-ruthenium-based hetero co-dendritic structure nanoparticles.

For example, copper sulfide nano hexagonal plates can be used, which are represented by the chemical formula Cu_{1.94}S. These copper sulfide nano hexagonal plates serve as precursors for synthesizing the aforementioned iridium-ruthenium-based hetero co-dendritic structure nanoparticles.

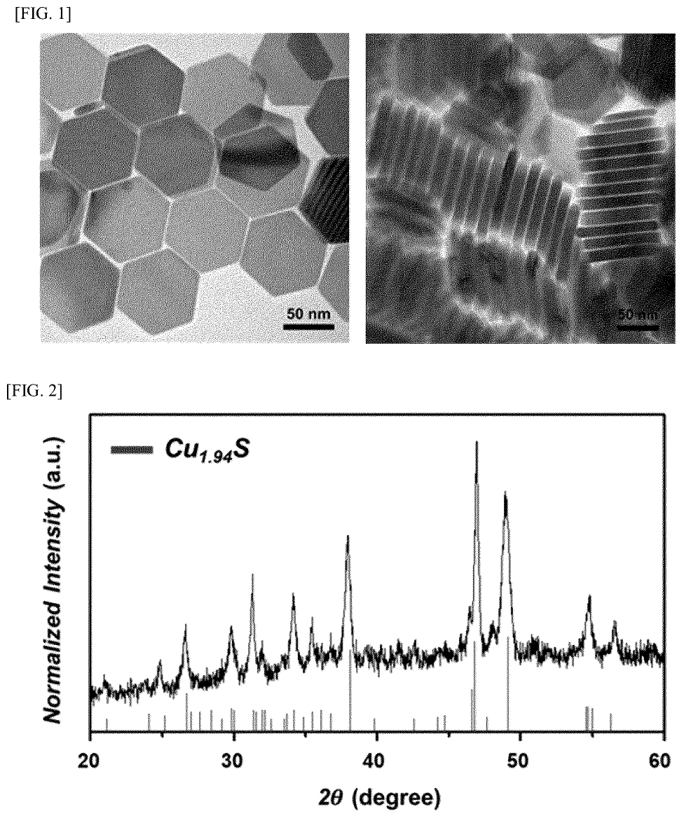

FIG. 1 would typically showcase the external appearance of these copper sulfide nano hexagonal plates, while FIG. 2 would display their crystal structure.

Specifically, these nano hexagonal plates of copper sulfide are synthesized using the chemical formula Cu_{1.94}S.

Here, the metal sulfides (MxS) utilized can include not only copper-based sulfides with chemical formulas such as Cu₂S, Cu_{1.8}S, Cu_{1.75}S, but also cobalt-based sulfides represented by formulas like CoS, Co₉S₈, Co₃S₄.

### Synthesis of Copper Sulfide (Cu_{1.94}S) Hexagonal Plates

Copper Thiocyanate (CuSCN) weighing 24.3 mg (0.2 mmol) was quantitatively transferred into a 100 mL reaction vessel, to which 10 mL of oleylamine was added and dissolved. The mixture was then reacted under an argon atmosphere at 140° C. for 30 minutes to obtain Cu_{1.94}S hexagonal nanoplates. To the reaction product containing dispersed Cu_{1.94}S, toluene and methanol (20 mL) were added, followed by centrifugation to precipitate the reaction product (Cu_{1.94}S). The supernatant was discarded, and the precipitated particles were dried to obtain Cu_{1.94}S in powder form.

Moreover, using the described synthesis method, metal sulfides (MxS) such as Cu₂S, Cu_{1.8}S, and Cu_{1.75}S, which are copper-based sulfides, can also be synthesized.

2) Manufacture of Oxidation Catalyst with Iridium Ruthenium-Based Co-Dendritic Structure

### Example 1: Fabrication of a Catalyst with a Co-Dendritic Structure Based on Ruthenium Iridium (RuIr) Using Manganese Dopant

Copper sulfide (Cu_{1.94}S) weighing 20 mg, ruthenium(III) acetylacetonate weighing 298.7 mg (0.15 mmol), iridium(III) acetylacetonate weighing 73.4 mg (0.075 mmol), and manganese(III) acetylacetonate weighing 3.5 mg (0.01 mmol) were accurately measured and placed into a 100 mL reaction vessel. Oleylamine (10 mL) was added, and the mixture was dissolved under vacuum and stirred vigorously at 80° C. Subsequently, the reaction was conducted under an argon atmosphere at 240° C. for 1 hour to fabricate a manganese-doped RuIr oxidation catalyst.

Thus, a catalyst with a nano-cactus shape (Mn-doped RuIr nanocactus; Mn—RuIr NCT) was obtained.

To the reaction product containing dispersed Mn—RuIr NCT, toluene and methanol (20 mL) were added, and the mixture was centrifuged to precipitate the Mn—RuIr NCT. The supernatant was discarded, and the settled particles were dried to obtain Mn—RuIr NCT in powder form.

It is to be noted that the metal sulfide (MxS), ruthenium acetylacetonate, iridium acetylacetonate, and transition metal compound can be mixed and used within a weight ratio range of 0.5˜1:7˜15:1.5˜4:0.1˜0.3

### Example 2: Fabrication of Oxidation Catalyst with Co-Dendritic Structure Based on Ruthenium Iridium Using Fe, Ni, Co Dopants

Substituting the manganese precursor, equal amounts of iron(III) acetylacetonate, nickel(II) acetylacetonate, and cobalt(III) acetylacetonate were used, and following the method described in Example 1, transition metal-doped Fe—RuIr NCT, Ni—RuIr NCT, and Co—RuIr NCT were fabricated respectively.

### Comparative Example 1: Fabrication of Oxidation Catalyst with Co-Dendritic Structure Based on Ruthenium Iridium Using a High Amount of Mn Dopant

Apart from using five times the amount of the manganese precursor, the H—Mn—RuIr NCT was fabricated using the method described in Example 1.

### Comparative Example 2: Fabrication of Oxidation Catalyst with Co-Dendritic Structure Based on Ruthenium Iridium without Dopants

Excluding the manganese precursor, an undoped RuIr NCT was fabricated using the method described in Example 1.

### Comparative Example 3: Fabrication of Iridium Ruthenium Alloy Nanocatalyst without Using Metal Sulfide (MxS) Precursors

Iridium(III) chloride (8.9 mg, 0.03 mmol), ruthenium(III) chloride (24.9 mg, 0.12 mmol), and hexadecyltrimethylammonium bromide (528.4 mg, 1.45 mmol) were accurately weighed and placed into a 100 mL reaction vessel. Anhydrous ethanol (40 mL) was added, and the mixture was vigorously stirred to dissolve. Using a syringe pump, 0.2 M sodium borohydride solution (9 mL) was added dropwise to the solution. After reacting for 12 hours, ethanol (20 mL) and distilled water (15 mL) were added to the reaction mixture containing the synthesized RuIr NPs. The mixture was then centrifuged to precipitate the RuIr NPs. The supernatant was discarded, and the settled particles were dried to obtain RuIr NPs in powder form.

(2) Basic Characterization Analysis of Oxidation Catalysts after Fabrication

Following the synthesis method described earlier, basic characterization analyses were conducted on materials such as Mn-doped Mn—RuIr NCT, Fe-doped Fe—RuIr NCT, Ni-doped Ni—RuIr NCT, Co-doped Co—RuIr NCT, undoped RuIr NCT, and highly Mn-doped H—Mn—RuIr NCT. X-ray diffraction analysis (XRD) and Transmission Electron Microscopy (TEM) were utilized for material property analysis.

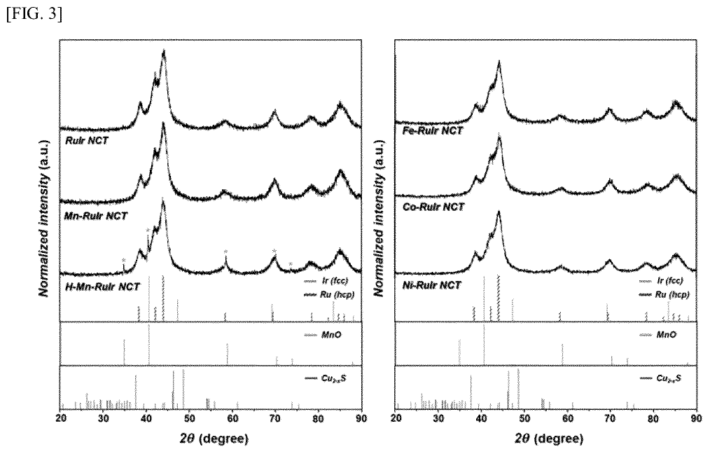

Referencing FIG. 3, the synthesized nanocatalysts displayed predominantly hexagonal close-packed (HCP) structure of ruthenium peaks in XRD analysis, with no significant difference observed in crystal structure across samples.

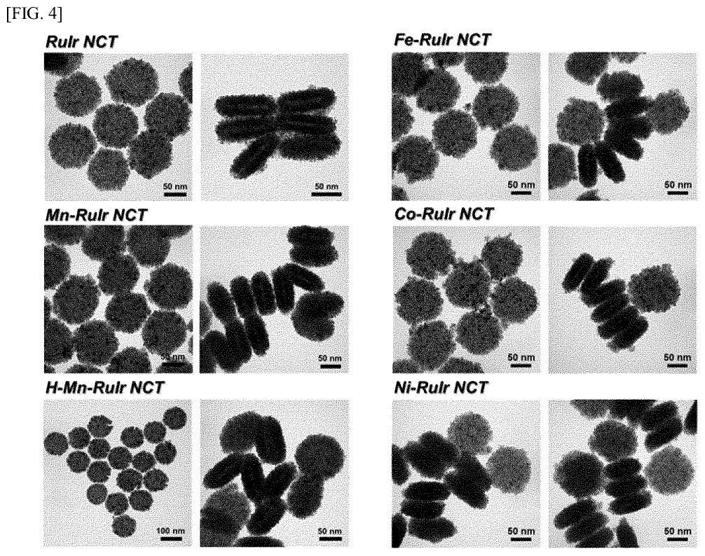

In FIG. 4, TEM images revealed that all nanocatalysts exhibited a nano cactus shape, suggesting that the morphology is independent of the presence or type of dopant.

However, for H—Mn—RuIr NCT, which had a fivefold increase in manganese dopant, MnO phases were observed in X-ray diffraction analysis, potentially negatively impacting the oxygen evolution reaction (OER) activity.

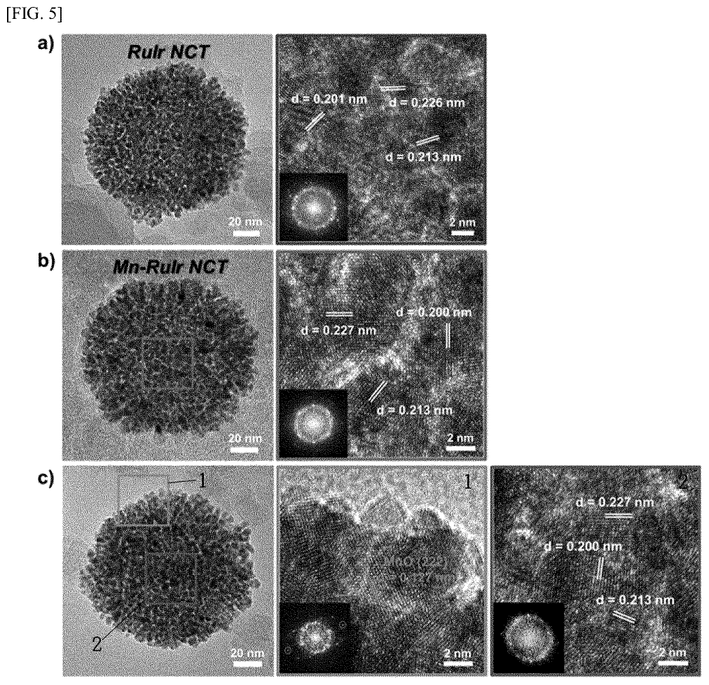

(a), (b) and (c) of FIG. 5 present high-resolution TEM (HRTEM) images and Fast Fourier Transform (FFT) patterns of synthesized RuIr NCT, Mn—RuIr NCT, and H—Mn—RuIr NCT, respectively. In HRTEM images, the white markings clearly indicate the lattice fringes of metallic Ru.

In (c) of FIG. 5, the orange markings represent the lattice fringes corresponding to the (222) plane of MnO, with a spacing of 0.127 nm, aligning with the results from X-ray diffraction analysis.

To observe changes in the synthesis mechanism depending on the presence of manganese dopant, particle formation over time was studied using TEM images, Energy Dispersive X-ray Spectroscopy (EDX) analysis, and X-ray diffraction, with and without manganese dopant.

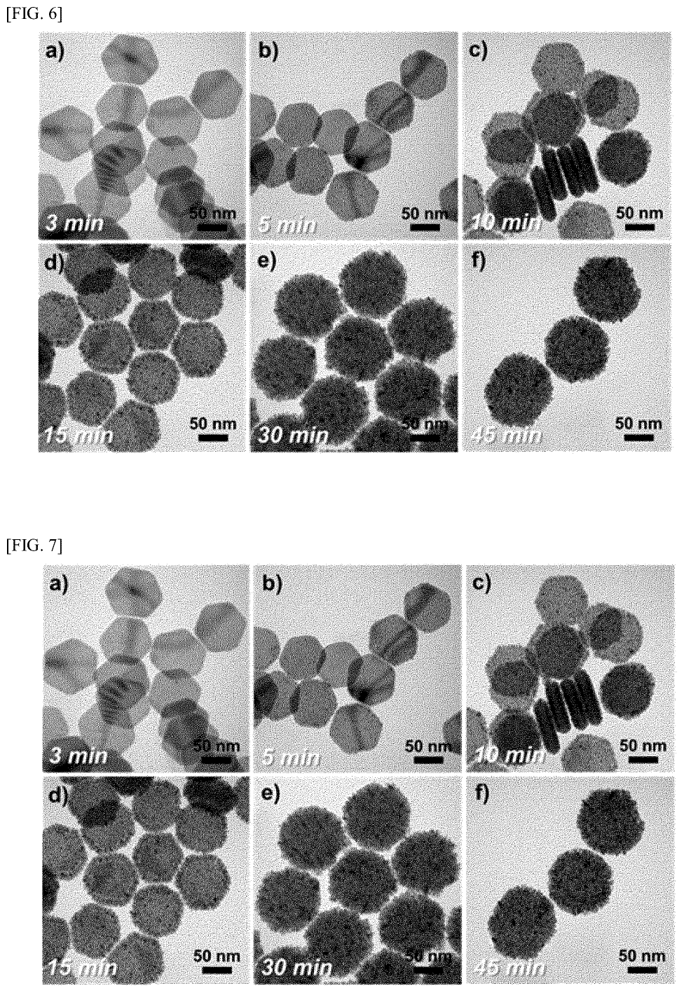

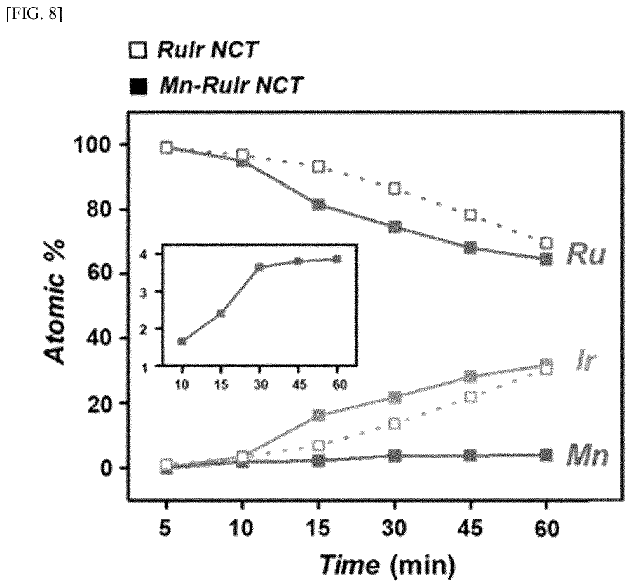

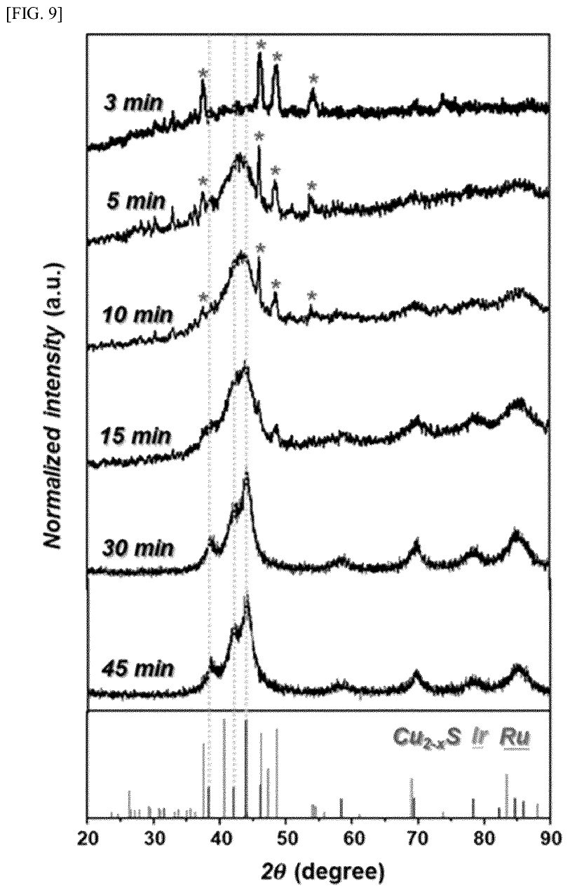

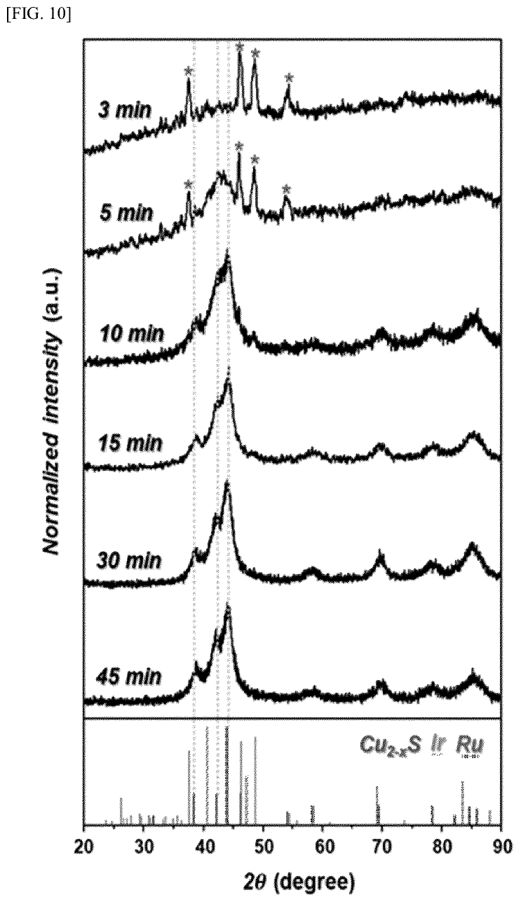

FIGS. 6 and 7 display TEM images of RuIr NCT and Mn—RuIr NCT over time, respectively. FIG. 8 presents a chart of EDX analysis results over time, and FIGS. 9 and 10 show X-ray diffraction patterns of RuIr NCT and Mn—RuIr NCT over time, respectively.

After an initial reaction time of 3 minutes, only Cu1.94S hexagonal nanoplates, used as precursors, were observed regardless of the presence of manganese dopant.

After 5 minutes, island-shaped particles were observed on the surface of Cu_{1.94}S hexagonal nanoplates in TEM images, and results from X-ray diffraction and EDX analyses indicated a composition higher in ruthenium relative to iridium.

After 10 minutes, in the presence of manganese dopant, the ratio of Ir increased faster, and manganese dopant was also observed in EDX analysis.

These results suggest that the doping of manganese promotes the reduction of iridium. FIG. 6 presents the redox reaction between manganese dopant and iridium precursor. The standard reduction potential difference facilitates electron transfer from Mn3+ to Ir3+ ions, promoting iridium reduction while generating Mn4+. The produced Mn4+ ions are reduced back to Mn3+ ions in a high-temperature reduction environment, participating in a repetitive redox reaction that promotes the reduction of Ir3+ ions.

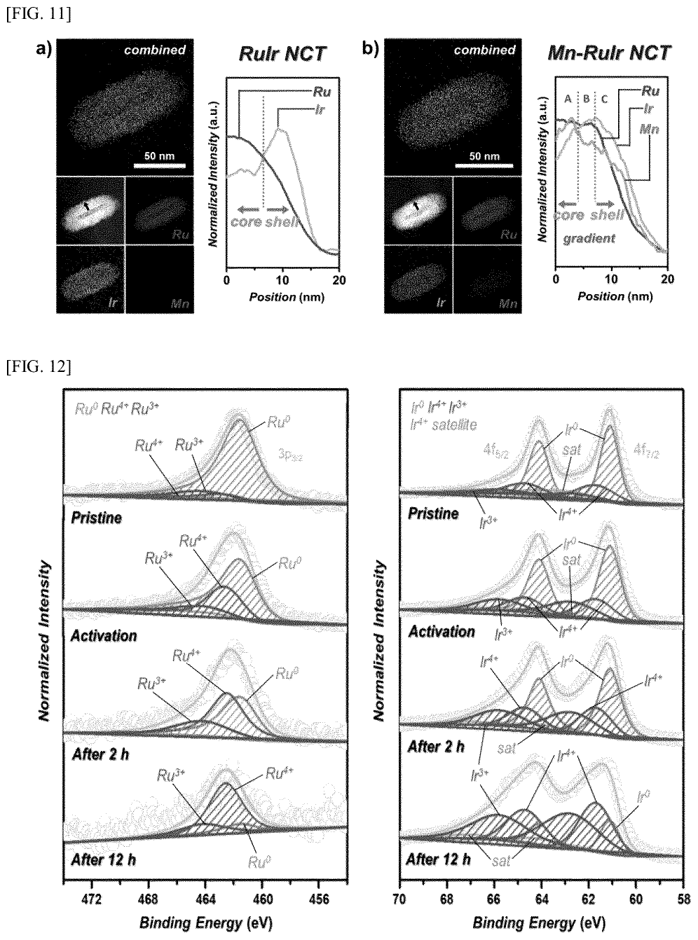

Through such mechanisms, manganese dopant enhances the mixing of iridium and ruthenium, with the final product showing a composition distribution of ruthenium and iridium more mixed in the case of Mn-doped (Mn—RuIr NCT) than in the undoped case (RuIr NCT), as seen in FIG. 11.

The fine-tuning of composition distribution within the particles through doping presents a new methodology for controlling the surface exposure of ruthenium, which can contribute to the activity and stability of the oxygen evolution reaction (OER).

The compositionally modulated nanoparticles (Mn—RuIr NCT) utilizing Mn dopant were implemented into a heterostructure through electrochemical oxidation.

X-ray photoelectron spectroscopy (XPS) of electrochemically oxidized particles enabled the identification of the chemical bonding states of Mn—RuIr NCT and RuIr NCT.

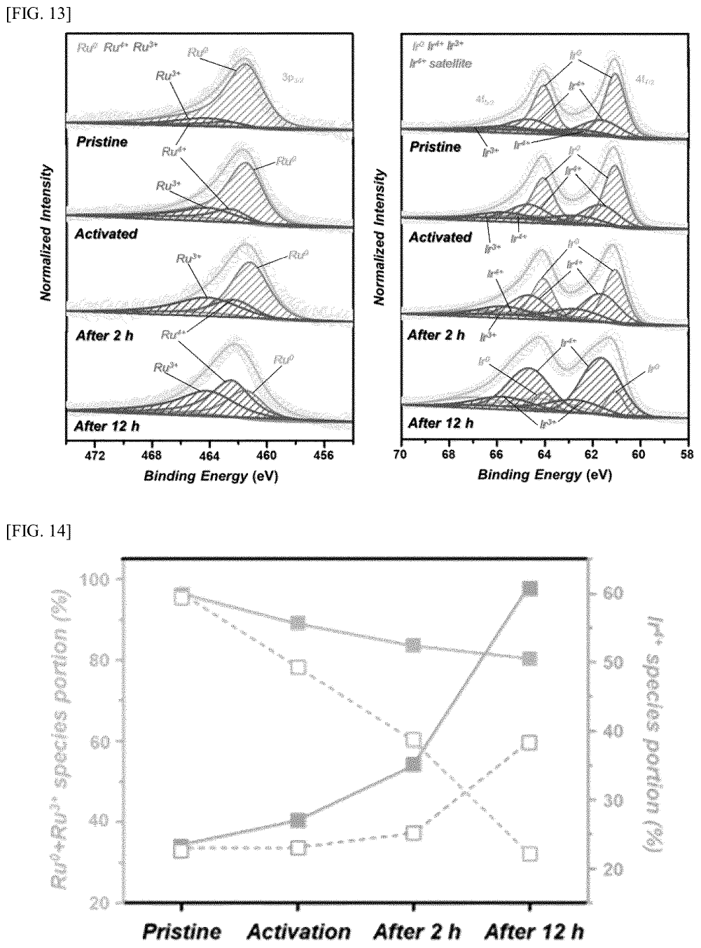

FIGS. 12 and 13 illustrate the Ru and Ir XPS results of RuIr NCT and Mn—RuIr NCT, respectively, before activation, after electrochemical activation, and after chronoamperometry measurements.

Referencing FIGS. 12 and 13, RuIr NCT and Mn—RuIr NCT exhibit core level peaks of 0, +3, and +4 oxidation states within the Ru 3p and Ir 4f regions. Before electrochemical oxidation, both samples show peaks of 0 valent Ru 3p and Ir 4f, with slight peaks of +3 and +4 valent Ir 4f.

From FIG. 14, after electrochemical oxidation, the oxidation of Ru 3p in Mn—RuIr NCT proceeds more slowly compared to RuIr NCT, while the oxidation of Ir 4f is faster. Consequently, after 12 hours of electrochemical oxidation, Mn—RuIr NCT possesses a heterostructure with a higher ratio of active lower oxidation state Ru and a higher amount of stable +4 Ir compared to RuIr NCT, which shows faster oxidation of Ru and relatively slower oxidation of Ir.

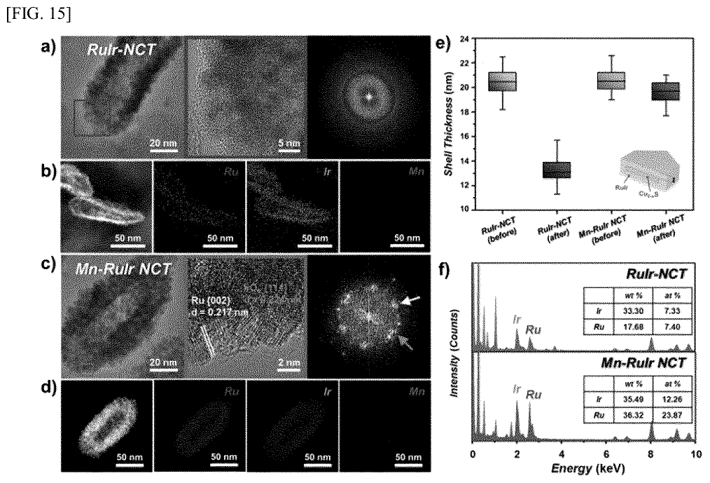

(a) and (c) of FIG. 15 present HRTEM images and their FFT patterns of RuIr NCT and Mn—RuIr NCT, respectively, after 6 hours of chronoamperometric measurement at 10 mA/cm\hat{ }2. Mn-RuIr shows lattice fringes corresponding to the (002) plane of metallic Ru with a spacing of 0.217 nm and adjacent lattice fringes corresponding to the (111) plane of IrO2 with a spacing of 0.224 nm, even after chronoamperometry. In contrast, RuIr NCT has amorphous particles without clear crystallinity.

Furthermore, (b) and (d) of FIG. 15 show EDX mapping images of RuIr NCT and Mn—RuIr NCT, respectively, after 6 hours of chronoamperometric measurement, indicating a difference in particle thickness between the two catalysts.

According to (e) of FIG. 15, the thickness of particles shows an average decrease of ˜1 nm for Mn—RuIr NCT but about ˜8 nm for RuIr NCT, suggesting a significant loss of Ru during the chronoamperometric measurements.

(f) of FIG. 15 shows the elemental ratio of Ru and Ir from EDX analysis, where Mn—RuIr NCT maintains a 1:2 ratio well, while in RuIr NCT, Ru dissolves more quickly, changing to a 1:1 ratio.

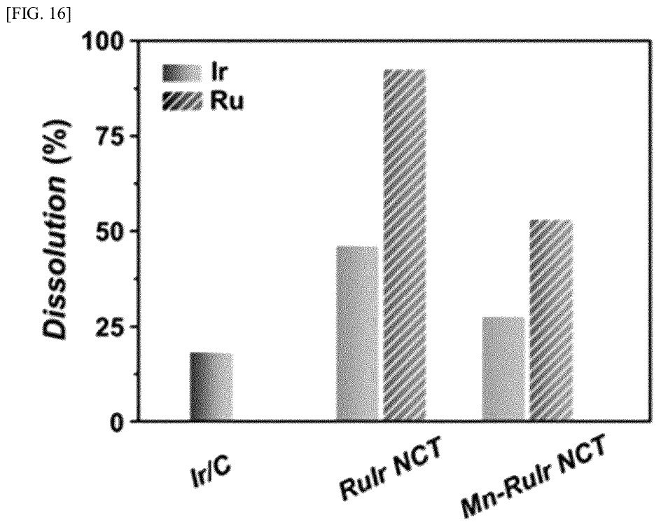

FIG. 16 presents the results measured by Inductively Coupled Plasma Mass Spectrometry (ICP-MS) of the amount of metal dissolved during 6 hours of oxygen evolution reaction (OER) chronoamperometric measurement, showing that the amount of Ru dissolved from RuIr NCT is 1.75 times more than from Mn—RuIr NCT. These analyses demonstrate that the introduction of Mn dopant reduces the dissolution of Ru, contributing to the higher OER stability of Mn—RuIr NCT due to the stable maintenance of Ru.

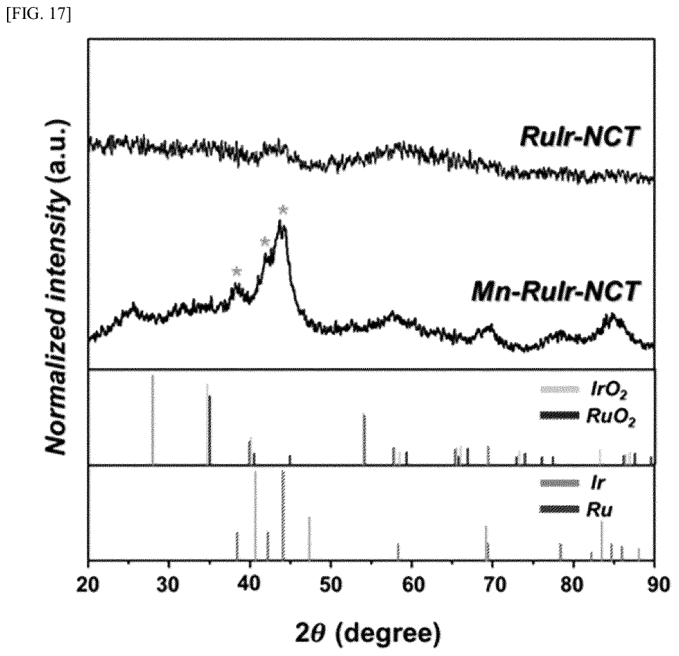

FIG. 17 shows the X-ray diffraction patterns of RuIr NCT and Mn—RuIr NCT, respectively, after 6 hours of continuous chronoamperometric measurement at 10 mA/cm\hat{ }2. Mn—RuIr NCT shows the XRD peak of metallic Ru, while RuIr NCT displays a broad peak, aligning with the HRTEM image results. The comprehensive results from XPS, HRTEM, ICP-MS, and X-ray diffraction patterns prove that Mn—RuIr NCT exhibits improved OER activity and stability compared to RuIr NCT.

### (3) Evaluation of Oxygen Evolution Reaction (OER) Activity in a Half-Cell Setup

As mentioned, the goal was to enhance the activity and stability of the oxygen evolution reaction (OER) by fine-tuning the composition distribution of ruthenium and iridium within the particles using manganese doping. The electrochemical characterization was conducted in a half-cell system with three electrodes: a working electrode (Glassy carbon electrode, GCE), a reference electrode (saturated Ag/AgCl electrode), and a counter electrode (graphite rod). The catalytic activity was evaluated using a rotating disc electrode coated with the catalysts. All electrochemical evaluations utilized a CHI potentiostat. OER measurements were performed at a rotation speed of 2500 rpm in a 0.1 M HClO4 solution, with the voltage referenced against a reversible hydrogen electrode (RHE) and aqueous resistance compensated to plot the polarization curves.

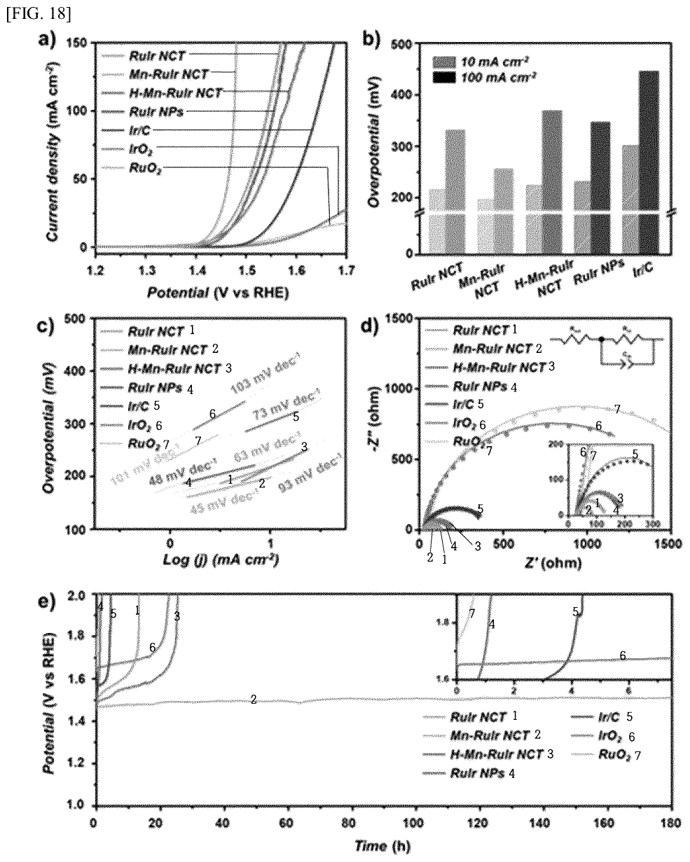

(a) of FIG. 18 shows the OER polarization curves for RuIr NCT, Mn—RuIr NCT, H—Mn—RuIr NCT, RuIr NPs, commercial Ir/C, commercial IrO2, and commercial RuO2, measured in a three-electrode system. (b) of FIG. 18 compares their overpotentials at 10 and 100 mA/cm\hat{ }2, (c) of FIG. 18 presents their Tafel plots, (d) of FIG. 18 shows Nyquist plots at an overpotential of 190 mV, and (e) of FIG. 18 illustrates the chronopotentiometric curves at 10 mA/cm\hat{ }2.

From (a) and (b) of FIG. 18, 2% Mn-doped Mn—RuIr NCT shows a notably low overpotential of 198 mV at 10 mA/cm\hat{ }2. In contrast, the undoped RuIr NCT, 14% Mn-doped H—Mn—RuIr NCT, and RuIr NPs exhibit overpotentials of 217 mV, 225 mV, and 232 mV, respectively, at the same current density, indicating a positive improvement in OER performance with the appropriate amount of Mn doping and nano cactus shape. Moreover, commercial Ir/C shows a higher overpotential of 302 mV at 10 mA/cm\hat{ }2, confirming that the introduction of Ru significantly contributes to improving OER performance. The overpotentials at 100 mA/cm\hat{ }2 for RuIr NCT, Mn—RuIr NCT, H—Mn—RuIr NCT, RuIr NPs, and commercial Ir/C are 313, 247, 346, 326, and 413 mV, respectively, demonstrating Mn—RuIr NCT's superior OER performance.

(c) of FIG. 18 shows the Tafel slopes for the catalysts, with RuIr NCT, Mn—RuIr NCT, H—Mn-RuIr NCT, RuIr NPs, commercial Ir/C, commercial IrO2, and commercial RuO2 having Tafel slopes of 63, 45, 93, 48, 73, 103, and 101 mV/dec-1, respectively. These results prove that appropriate Mn doping induces a higher reaction rate and better kinetics.

(d) of FIG. 18 presents the Nyquist plots, indicating that all plots consist of a single semicircle. The introduction of 2% Mn doping decreases the charge transfer resistance (Rct), suggesting that an optimal amount of Mn doping facilitates charge transfer, thereby contributing to improved OER performance.

Catalyst durability, a crucial factor in electrolysis, was assessed through accelerated durability tests and chronopotentiometric tests, using carbon paper electrodes (CPE, 1 cm×1 cm) instead of GCE for the latter measurements.

(e) of FIG. 18 demonstrates that Mn—RuIr NCT maintains high durability in the chronopotentiometric test at 10 mA/cm\hat{ }2, showing only a slight degradation of 40 m V after 180 hours, yet continuously generating oxygen.

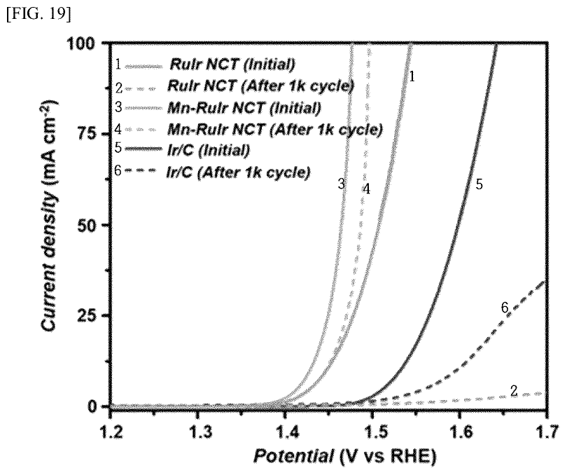

Furthermore, as indicated in FIG. 19, despite a shift in the polarization curve from 198 mV to 216 mV after 1000 cycles at 10 mA/cm\hat{ }2 for Mn—RuIr NCT, this shift is negligible compared to RuIr NCT and commercial Ir/C, evidencing Mn—RuIr NCT's high structural stability during cyclic voltammetry. Therefore, Mn—RuIr NCT exhibits higher stability and durability in OER compared to commercial catalysts.

### (4) Fabrication and Performance Evaluation of a Proton Exchange Membrane Water Electrolyzer (PEMWE)

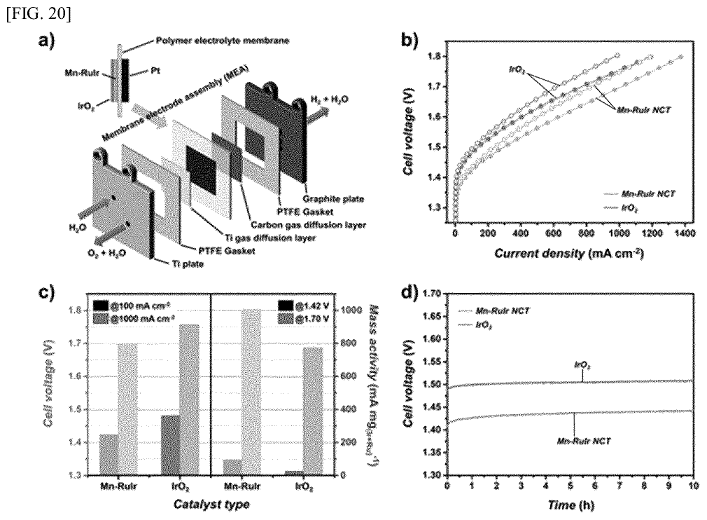

To explore practical application possibilities, a proton exchange membrane water electrolyzer (PEMWE) was constructed and its performance evaluated using the Mn—RuIr NCT. The structure of the PEMWE utilizing Mn—RuIr NCT is illustrated in (a) of FIG. 20, comprising a titanium plate, PTFE gasket, titanium gas diffusion layer, hydrogen evolution electrode, membrane layer, oxygen evolution electrode, carbon gas diffusion layer, PTFE gasket, and graphite plate.

The hydrogen evolution electrode was fabricated by spray-coating commercial Pt/C, consisting of catalyst, ionomer solution, isopropyl alcohol, and distilled water. The precious metal load on the catalyst per unit area was 0.8 mg_Pt/cm\hat{ }2.

The oxygen evolution electrode was prepared by spray-coating Mn—RuIr NCT and commercial IrO2, with the precious metal load per unit area being 1 mg_Ir+Ru/cm\hat{ }2 at a 1:1 ratio of Ir to Ru. A double-layered thin film structure of Mn—RuIr NCT and IrO2 was created for the PEMWE evaluation, with the commercial IrO2 thin film fabricated considering the same amount of precious metal.

The performance evaluation of this PEMWE was conducted using an electrochemical workstation (Metrohm Autolab PGSTAT302N) equipped with a 10A current amplifier. The PEMWE operated at 80 degrees Celsius, atmospheric pressure, and a water flow rate of 15 mL/min.

(b) of FIG. 20 presents the PEMWE cell polarization curves before and after a 10-hour chronopotentiometric test at 100 mA/cm\hat{ }2 for the Mn—RuIr NCT and commercial IrO2 double-layered catalyst and commercial IrO2 alone. (c) of FIG. 20 compares their cell voltages at 100 and 1000 mA/cm\hat{ }2 current densities and shows the mass activity at 1.42V and 1.70V. (d) of FIG. 20 illustrates the chronopotentiometric curve at 100 mA/cm\hat{ }2 current density.

According to FIG. 20, the double-layered structure of Mn—RuIr NCT and commercial IrO2 shows higher activity compared to commercial IrO2 alone and remains stable after a 10-hour chronopotentiometric test. The usage of Ir is reduced by 50% compared to commercial IrO2, substituting it with Ru, which is more than ten times cheaper than Ir. This result could significantly contribute to the commercialization of PEMWE.

Based on the OER polarization curves, accelerated durability tests, chronopotentiometric tests, and the fabrication and performance of the water electrolysis device, it's clear that Mn—RuIr NCT can act as a highly active and stable catalyst for OER and be applied as a commercial catalyst. This invention confirms that it's possible to manufacture oxygen evolution catalysts with excellent activity and stability while reducing the loading of iridium and ruthenium by using metal sulfides (MxS) as precursors and doping with transition metal elements, offering a simple method for mass production of anode catalysts.

The embodiments described above are merely illustrative of the preferred embodiments of the invention and are not intended to limit the invention. Within the technical spirit and scope of the invention as claimed, various modifications, variations, or replacements can be made by those skilled in the art. These modifications are considered to fall within the technical scope of the invention. The specific scope of protection for this invention will be clarified by the appended claims.

This invention pertains to an iridium-ruthenium-based anode catalyst for water electrolysis, its manufacturing method, and a water electrolysis device utilizing it, which are capable of implementing a heterostructure by altering the composition distribution within the catalyst through the introduction of dopants, thereby ensuring high activity and stability for the oxygen evolution reaction (OER). The invention is related to a technology with high industrial applicability, aiming to enhance the efficiency and durability of water electrolysis systems. This is particularly significant for green hydrogen production, where the efficiency of the OER process is crucial for the overall energy efficiency and economic viability of hydrogen production.

1. An iridium-ruthenium-based oxide anode catalyst for water electrolysis comprising:
a heterostructure within the particles, wherein different phases within the particles are adjacent to each other,
wherein the different phases within the particles consist of iridium and ruthenium,
wherein the catalyst is synthesized using metal sulfides (MxS) as precursors, and
wherein the catalyst is characterized by the introduction of transition metal elements as dopants.

2. The iridium-ruthenium-based oxide anode catalyst for water electrolysis according to claim 1, wherein the anode catalyst comprises nanoparticles having a nano-cactus shape.

3. The iridium-ruthenium-based oxide anode catalyst for water electrolysis according to claim 1, wherein the metal sulfides (MxS) comprise:
M as a transition metal cation and S as a sulfide anion,
wherein M includes at least one selected from the group consisting of Mn, Fe, Ni, Co, Cr, Cu, and Zn.

4. The iridium-ruthenium-based oxide anode catalyst for water electrolysis according to claim 1, wherein the metal sulfides (MxS) comprise:
M as a transition metal cation and S as a sulfide anion,
wherein the metal sulfides have an external shape of nano hexagonal plates or octahedra, and a crystal structure that is either a face-centered cubic lattice (FCC) or a hexagonal close-packed lattice (HCP).

5. The iridium-ruthenium-based oxide anode catalyst for water electrolysis according to claim 1, wherein the metal sulfides (MxS) are one or more selected from the group consisting of Cu₂S, Cu_{1.94}S, Cu_{1.8}S, Cu_{1.75}S, CoS, Co₉S₈, and Co₃S₄.

6. The iridium-ruthenium-based oxide anode catalyst for water electrolysis according to claim 1, wherein the transition metal element is selected from one or more of Mn, Fe, Ni, Co, Cr, Cu, and Zn.

7. A method for manufacturing an iridium-ruthenium-based oxide anode catalyst for water electrolysis, wherein particles are synthesized by introducing a transition metal element as a dopant to regulate the reduction rate of a precursor, and to have a heterostructure with different phases adjacent to each other within the particle,
wherein in the different phases within the particle are iridium and ruthenium.

8. A method for manufacturing an iridium-ruthenium-based oxide anode catalyst for water electrolysis, comprising:
(A) providing a precursor for the synthesis of nanoparticles having a heterostructure;
(B) synthesizing an iridium-ruthenium-based oxide anode catalyst having a heterostructure through the synthesis using the precursor and a transition metal element as a dopant.

9. The method for manufacturing an iridium-ruthenium-based oxide anode catalyst for water electrolysis according to claim 8,
(C) further comprising a step of pulverizing the product of step (B).

10. The method for manufacturing an iridium-ruthenium-based oxide anode catalyst for water electrolysis according to claim 7, wherein the precursor is a metal sulfide (MxS).

11. The method for manufacturing an iridium-ruthenium-based oxide anode catalyst for water electrolysis according to claim 10,
the metal sulfide (MxS) consists of M as a transition metal cation and S as a sulfide anion, where M includes at least one selected from Mn, Fe, Ni, Co, Cr, Cu, and Zn.

12. The method for manufacturing an iridium-ruthenium-based oxide anode catalyst for water electrolysis according to claim 10,
wherein the metal sulfide (MxS) consists of M as a transition metal cation and S as a sulfide anion, where the morphology is in the form of nano hexagonal plates or octahedra, and the crystal structure is a face-centered cubic lattice (FCC) or a hexagonal close-packed lattice (HCP).

13. The method for manufacturing an iridium-ruthenium-based oxide anode catalyst for water electrolysis according to claim 10, wherein the metal sulfide (MxS) is selected from one or more of Cu₂S, Cu_{1.94}S, Cu_{1.8}S, Cu_{1.75}S, CoS, Co₉S₈, and Co₃S₄.

14. The method for manufacturing an iridium-ruthenium-based oxide anode catalyst for water electrolysis according to claim 9, wherein the dopant is selected from one or more of Mn, Fe, Ni, Co, Cr, Cu, Zn.

15. The method for manufacturing an iridium-ruthenium-based oxide anode catalyst for water electrolysis according to claim 8, wherein the following steps in the (A) phase:
(1) dissolving copper thiocyanate (CuSCN) in oleylamine;
(2) reacting the product of step (1) under an argon atmosphere and at a temperature condition of 120° C.˜150° C. and 20˜40 minutes to synthesize copper-based metal sulfide;
(3) adding toluene and methanol to the synthesized copper-based metal sulfide from step (2), then using centrifugation to settle the copper-based metal sulfide;
(4) discarding the supernatant from step (3) and drying the settled particles to produce a powder; thereby synthesizing and providing the precursor.

16. The method for manufacturing an iridium-ruthenium-based oxide anode catalyst for water electrolysis according to claim 15, wherein the copper-based metal sulfide has a composition of any one of Cu₂S, Cu_{1.94}S, Cu_{1.8}S, Cu_{1.75}S.

17. The method for manufacturing an iridium-ruthenium-based oxide anode catalyst for water electrolysis according to claim 8, wherein the following steps in the (B) phase:
(1) placing metal sulfide (MxS), ruthenium acetylacetonate, iridium acetylacetonate, and a transition metal material in a reaction vessel along with oleylamine;
(2) stirring the product from step (1) under a vacuum atmosphere and at a temperature condition of 70° C.˜90° C.;
(3) the product from step (2) is reacted under an argon atmosphere and at a temperature condition of 220° C.˜260° C. and 40˜60 mintes to obtain an iridium-ruthenium-based oxide anode catalyst doped with transition metals.

18. The method for manufacturing an iridium-ruthenium-based oxide anode catalyst for water electrolysis according to claim 17, wherein the metal sulfide (MxS), ruthenium acetylacetonate, iridium acetylacetonate, and transition metal material are added in a weight ratio of 0.5˜1:7˜15:1.5˜4:0.1˜0.3.

19. The method for manufacturing an iridium-ruthenium-based oxide anode catalyst for water electrolysis according to claim 17, wherein the transition metal material used in step (1) is selected from any one of manganese acetylacetonate, iron acetylacetonate, nickel acetylacetonate, cobalt acetylacetonate, and zinc acetylacetonate.

20. A water electrolysis apparatus characterized by including an oxygen evolution electrode made with an iridium-ruthenium-based oxide anode catalyst according to claim 1.

21. A water electrolysis apparatus characterized by including an oxygen evolution electrode made with an oxide anode catalyst manufactured by the method for manufacturing an iridium-ruthenium-based oxide anode catalyst according to claim 7.
